(19) United States
(12) Patent Application Publication
(10) Pub. No.: US 2018/0164578 A1
(43) Pub. Date: Jun. 14, 2018

(54) MICROELECTROMECHANICAL LIGHT VALVE, DISPLAY SCREEN AND DISPLAY DEVICE

(71) Applicant: Shenzhen China Star Optoelectronics Technology Co., Ltd., Shenzhen, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 15/115,894

(22) PCT Filed: Jul. 11, 2016
(86) PCT No.: PCT/CN2016/089604

§ 371 Date: Aug. 1, 2016

(30) Foreign Application Priority Data
Jun. 3, 2016 (CN) 201610390206.9

(51) Int. Cl. G02B 26/02; G09G 3/3233; G09G 3/34

(52) U.S. Cl. CPC G02B 26/02; G09G 3/3406; G09G 3/3233

(57) ABSTRACT

The invention provides a microelectromechanical light valve, a display screen and a display device. The microelectromechanical light valve includes a fixed grating and a movable grating. The fixed grating is fixed on a substrate. The movable grating is disposed above the fixed grating and parallel to the fixed grating, and further can be shifted relative to the fixed grating in a plane which the movable grating is located in to thereby adjust a size of slits between the fixed grating and the movable grating and allowing light to transmit through. The display screen can maintain uniformity and stability of display screen brightness while realizing the switching between dark state and bright state of the display screen, and meanwhile can simplify the driving circuit and increase pixel aperture ratio.

### TECHNICAL FIELD

The invention relates to the field of display technology, and more particularly to a microelectromechanical light value, a display screen and a display device.

### DESCRIPTION OF RELATED ART

As a new generation of display technology, AMOLED has the advantages of low power consumption, high color gamut, high brightness, high resolution, wide viewing angle, high response speed and so on, and therefore it is favored by the market.

In a TFT LCD, the brightness is controlled by voltage, as long as the accuracy of pixel voltage is controlled to a few millivolts, the non-uniformity can be restricted to be within about ±1% range as required. This is easy to be achieved, because in the TFT LCD, the pixel TFT does not need to convert/transform the transmitted signal voltage and only is used for delivering/transmitting the signal voltage directly from the data line to a switch on the pixel. However, in the AMOLED, the brightness is determined by a current flowing through the OLED itself, if it still is required to control the non-uniformity within the range of about ±1%, this means that the current control accuracy of the OLED is required within the range of about ±1%. Since most of existing IC circuits only transmit voltage signals rather than current signals, the AMOLED pixel needs to complete a difficult task, i.e., transforms the voltage signal to a current signal and then stores the transformed result into the pixel in a period of one frame. The actual development process of the AMOLED pixel proves that this is a task very difficult to accomplish. As shown in FIG. 1, FIG. 1 is a diagram of a traditional 2T1C AMOLED current-driven circuit. Threshold voltages and channel mobilities of α-Si TFTs used for AMOLED are not uniform in spatial distribution, and further the threshold voltages and the mobilities of the α-Si TFTs for AMOLED would drift along the time, these drawbacks would result in unevenness and instability of display screen brightness. Therefore, it is necessary to introduce various pixel compensation circuits, so as to make the uniformity and stability of the display screen light-emitting brightness meet the requirements of goods. However, after the pixel compensation circuit is introduced, the driving circuit of AMOLED becomes more complex, resulting in a lower aperture ratio of the display screen. As shown in FIG. 2, FIG. 2 is a schematic view of a pixel structure of a panel in the prior art and illustrates a pixel area 31 and a driving circuit area 32.

### SUMMARY

Accordingly, the invention provides a microelectromechanical light value, a display screen and a display device, which can solve the issue of low aperture ratio of display screen caused by the complex driving circuit in the prior art.

In order to solve the above technical issue, a technical solution proposed by the invention is to provide a microelectromechanical light valve. The microelectromechanical light valve includes a fixed grating and a movable grating. The fixed grating is fixed on a substrate. The movable grating is disposed above the fixed grating and parallel to the fixed grating, and further is shiftable/movable relative to the fixed grating in a plane which the movable grating is located in to thereby adjust a size of slits between the fixed grating and the movable grating and allowing light to transmit through.

Extending directions of the slits between the fixed grating and the movable grating are same.

In order to solve the above technical issue, another technical solution proposed by the invention is to provide a display screen. The display screen includes a substrate, a backlight panel, a fixed grating and a movable grating. The backlight panel is disposed on the substrate. The fixed grating is disposed on the backlight panel. The movable grating is disposed above the fixed grating and parallel to the fixed grating, and further can be shifted relative to the fixed grating in a plane which the movable grating is located in to thereby adjust a size of slits between the fixed grating and the movable grating and allowing light emitted from the backlight panel to pass through, therefore for switching bright state and dark state of the display screen.

In an embodiment, extension directions of the slits between the fixed grating and the movable grating are same.

In an embodiment, the backlight panel is an OLED light-emitting backplane.

In an embodiment, the OLED light-emitting backplane includes R pixels, G pixels and B pixels. The R pixels, the G pixels and the B pixels are arranged in a strip manner.

In an embodiment, the R pixels are driven by a R circuit, the G pixels are driven by a G circuit, the B pixels are driven by a B circuit. The R circuit, the G circuit and the B circuit are independent from one another.

In an embodiment, the R circuit, the G circuit and the B circuit all are disposed at one side of the OLED light-emitting backplane.

In an embodiment, the backlight panel is covered with a packaging layer thereon to protect light-emitting devices on the backlight panel.

In order to solve the above technical issue, still another technical solution proposed by the invention is to provide a display device. The display device includes any one of the display screen.

Efficacy can be achieved by the invention is that: distinguished from the prior art, the invention disposes a fixed grating and a movable grating on the backlight panel and adjusts the size of slits between the fixed grating and the movable grating by the movement of the movable grating to make light quantity transmitted through the slits be changed, and thereby realizing the switching/conversion between dark stat and bright state for the display screen; since the invention can realize the switching between dark state and bright state of the display screen and maintain uniformity and stability of display screen brightness by the cooperation of the fixed grating and the movable grating, and further there is no need of adding compensation circuit, it can simplify the driving circuit and increase pixel aperture ratio.

### BRIEF DESCRIPTION OF THE DRAWINGS

In order to more clearly illustrate technical solutions of embodiments of the invention, drawings will be used in the description of the embodiments of the invention will be given a brief description below. Apparently, the drawings in the following description only are some of embodiments of the invention, the ordinary skill in the art can obtain other drawings according to these illustrated drawings without creative effort.

FIG. 1 is a diagram of a traditional 2T1C AMOLED current-driven circuit.

FIG. 2 is a schematic view of a pixel structure of a panel in the prior art.

FIG. 3 is a schematic structural cross sectional view of a display screen according to an embodiment of the invention.

FIG. 4 is a schematic view of a pixel structure of a display screen according to an embodiment of the invention.

FIG. 5 is a schematic view of a driving circuit of a display screen according to an embodiment of the invention.

FIG. 6 is a schematic structural view of a display device according to an embodiment of the invention.

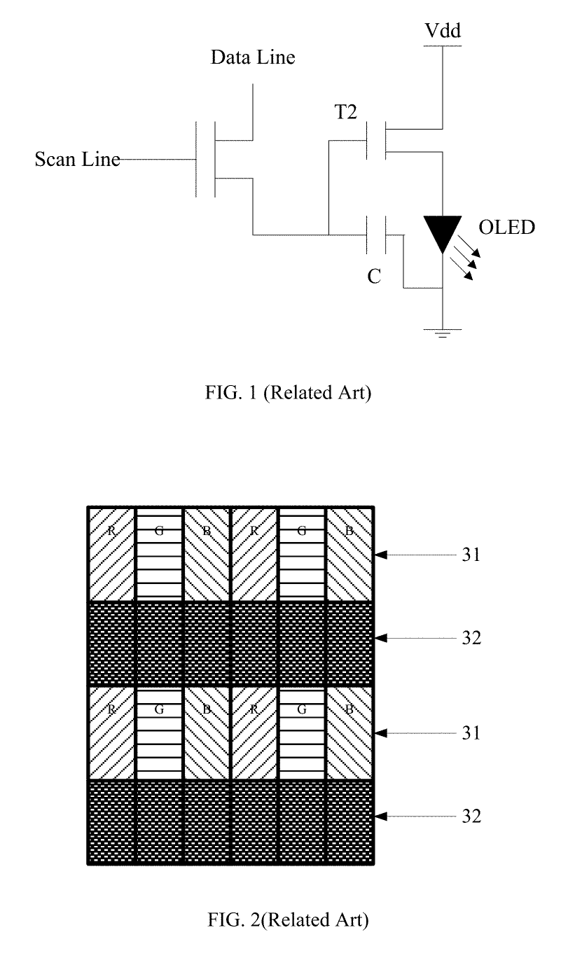

### DETAILED DESCRIPTION OF EMBODIMENTS

In the following, with reference to accompanying drawings of embodiments of the invention, technical solutions in the embodiments of the invention will be clearly and completely described. Apparently, the embodiments of the invention described below only are a part of embodiments of the invention, but not all embodiments. Based on the described embodiments of the invention, all other embodiments obtained by ordinary skill in the art without creative effort belong to the scope of protection of the invention.

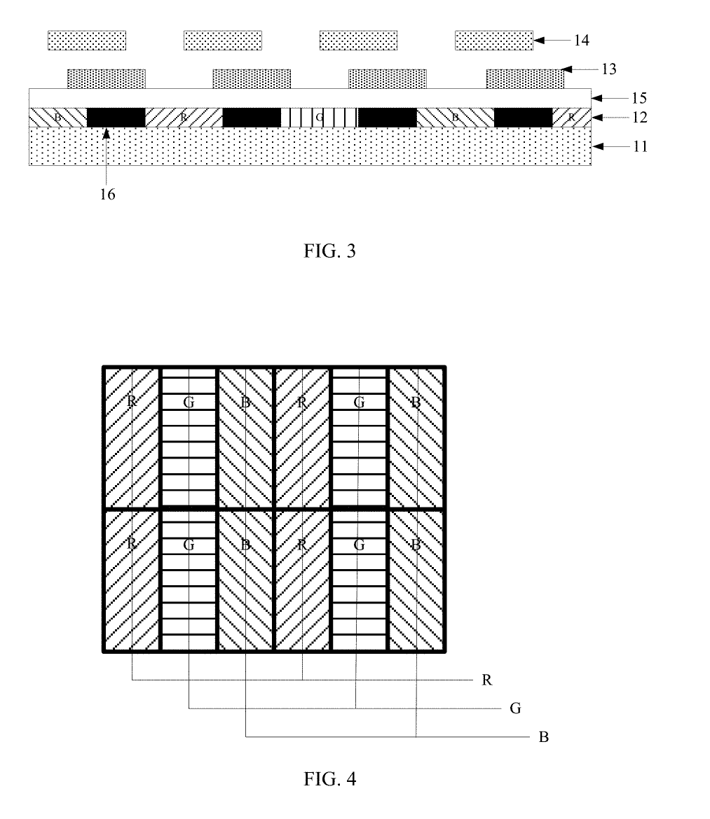

Referring to FIG. 3, FIG. 3 is a schematic structural cross sectional view of a display screen according to an embodiment of the invention.

The invention provides a display screen. The display screen includes a substrate 11, a backlight panel 12, a fixed gating 13 and a movable grating 14.

The backlight panel 12 is disposed on the substrate 11.

The fixed grating 13 is disposed on the backlight panel 12.

The movable grating 14 is disposed above the fixed grating 13 and parallel to the fixed grating 13, and further can be shifted with respect to the fixed grating 13 in a plane in which the movable grating is located 14. As illustrated in FIG. 3, the movable grating 14 can move leftward and rightward in the horizontal direction, while in the vertical direction a distance between the fixed grating 13 and the movable grating 14 is constant. By adjusting the size of slits between the fixed grating 13 and the movable grating 14 and allowing light emitted from the backlight panel 12 to transmit/pass through, the switching/conversion of bright state and dark state of the display screen can be realized.

Specifically, when the fixed grating 13 and the movable grating 14 have a potential difference existed therebetween, the fixed grating 13 and the movable grating 14 have different types of charges, an electrostatic force correspondingly is generated between the fixed grating 13 and the movable grating 14. Under the effect of the electrostatic force, the movable grating 14 and the fixed grating 13 located therebelow form a relative displacement, RGB backlight passing through the fixed grating 13 can selectively transmit through the movable grating 14 and thereby realize the switching between bright state and dark state of light valve.

Distinguished from the prior art, the invention disposes the fixed grating 13 and the movable grating 14 above the backlight panel 12, adjusts the size of slits between the fixed grating and the movable grating 14 by the movement of the movable grating 14 to make the quantity/amount of light transmitted through the slits be changed and thereby realize the switching between dark stage and bright state for the display screen. Since the invention can realize the switching/conversion between dark stage and bright state for the display screen and maintain uniformity and stability of display screen brightness by cooperation of the fixed grating 13 and the movable grating 14, and further there is no need to add compensation circuit, therefore it can simplify the driving circuit and increase pixel aperture ratio.

In the illustrated embodiment, the backlight panel 12 is covered with a packaging layer 15 thereon to protect light-emitting devices on the backlight panel 12, and the fixed grating 13 is fixed on the packaging layer 15.

Specifically, extension directions of the slits formed between the fixed grating 13 and the movable grating 14 are same. For example, the silts formed between the fixed grating 13 and the movable grating 14 in FIG. 3 all extend along the direction perpendicular to the paper plane.

In the illustrated embodiment, the backlight panel 12 is an OLED light-emitting backplane. The light source is an OLED point light source. The OLED light-emitting backplane include R (red) pixels, G (green) pixels and B (blue) pixels. The R pixels, the G pixels and the B pixels are distributed in strip shape. As shown in FIG. 4, FIG. 4 is a schematic view of a pixel structure of a display screen according to an embodiment of the invention. For example, in the pixel arrangement structure, each row of RGB pixels are arranged in a manner of R-G-B-R-G-B, so that pixels in a same column are the same, i.e., are R pixels, or G pixels or B pixels, so that the R pixels, the G pixels and the B pixels are arranged in a strip manner.

Please continue to refer to FIG. 3, in the illustrated embodiment, adjacent pixels are separated by a pixel defining layer 16.

The R pixels are driven by a R circuit, the G pixels are driven by a G circuit, and the B pixels are driven by a B circuit. The R circuit, the G pixel and the B circuit are mutually independent from one another. Therefore, an overall brightness of the R pixels can be adjusted by the R circuit, an overall brightness of the G pixels can be adjusted by the G circuit, and an overall brightness of the B pixels can be adjusted by the B circuit.

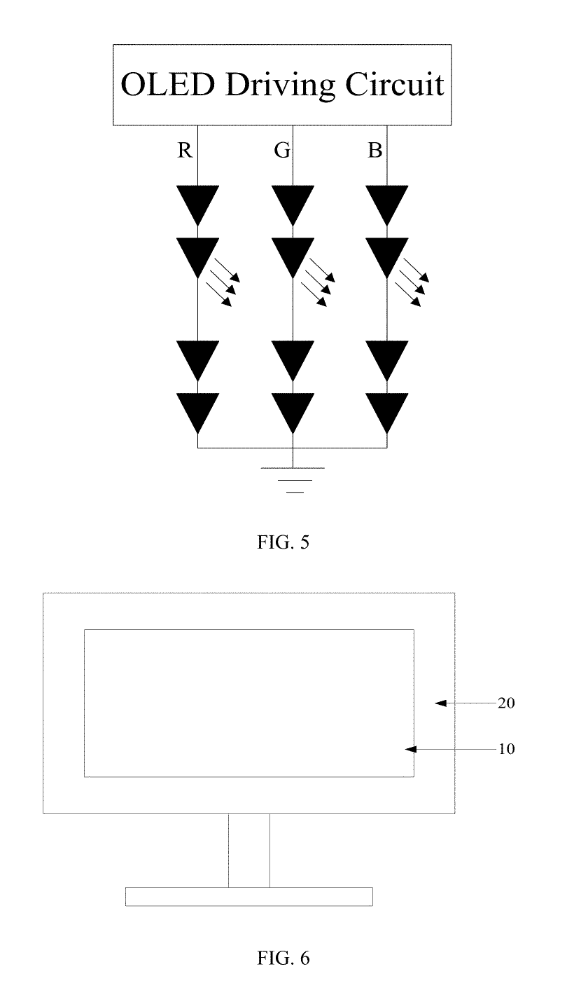

By the cooperation of the fixed grating 13 with the movable grating 14, it can simplify the driving circuit, so that the driving circuit can be disposed at a side of the backlight panel 12. As illustrated in FIG. 4, the R circuit, the G circuit and the B circuit all are disposed at one side of the OLED light-emitting backplane, which would not affect the pixel aperture ratio. As illustrated in FIG. 5, FIG. 5 is a schematic view of a driving circuit of a display screen according to an embodiment of the invention. Moreover, owing to the R pixels, the G pixels and the B pixels being distributed in strip manner, it can further simplify the driving circuit.

The invention further provides a microelectromechanical light valve. Please continue to refer to FIG. 3, the microelectromechanical light valve includes the fixed grating 13 and the movable grating 14. The fixed grating 13 is fixed on a substrate, e.g., the fixed grating 14 in FIG. 3 is fixed on the backlight panel 12. The movable grating 14 is disposed above the fixed grating 13 and can be shifted with respect to the fixed grating 13 in a plane in which the movable grating 14 is located to thereby adjust a size of slits between the fixed grating 13 and the movable grating 14 and allowing light to transmit/pass through, for realizing the switching/conversion of bright state and dark state of the display screen.

Specifically, extending directions of slits formed between the fixed grating 13 and the movable grating 14 are same. For example, in FIG. 3, the slits between the fixed grating 13 and the movable grating 14 all extend along a direction perpendicular to the paper plane.

Please refer to FIG. 6, FIG. 6 is a schematic structural view of a display device according to an embodiment of the invention.

The invention still further provides a display device. The display device includes an outer frame 20 and a display screen 10.

As shown in FIG. 3, the display screen 10 includes the substrate 11, the backlight panel 12, the fixed grating 13 and the movable grating 14.

The backlight panel 12 is disposed on the substrate 11.

The fixed grating 13 is disposed on the backlight panel 12.

The movable grating 14 is disposed above the fixed grating 13 and parallel to the fixed grating 13, and further can be shifted with respect to the fixed grating 13 in a plane in which the movable grating 14 is located. As shown in FIG. 3, the movable grating 14 can move leftward and rightward in the horizontal direction, while in the vertical direction a distance between the fixed grating 13 and the movable grating 14 is constant. By adjusting a size of slits between the fixed grating 13 and the movable grating 14 and allowing light emitted from the backlight panel 12 to transmit/pass through, it can realize the switching/conversion between bright state and dark state for the display screen.

Specifically, when the fixed grating 13 and the movable grating 14 have a potential difference existed therebetween, the fixed grating 13 and the movable grating 14 have different types of charges, an electrostatic force correspondingly is generated between the fixed grating 13 and the movable grating 14. Under the effect of the electrostatic force, the movable grating 14 and the fixed grating 13 disposed therebelow form a relative displacement, so that RGB backlight transmitted through the fixed grating 13 can selectively transmit through the movable grating 14, and the switching between dark state and bright state of the light valve is realized consequently.

In summary, the invention can maintain uniformity and stability of display screen brightness while realizing the conversion between dark state and bright state for the display screen, and meanwhile it further can simplify the driving circuit and increase pixel aperture ratio.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A microelectromechanical light valve comprising:
a fixed grating, fixed on a substrate;
a movable grating, wherein the movable grating is disposed above the fixed grating and parallel to the fixed grating, and further is shiftable with respect to the fixed grating in a plane which the movable grating is located in to thereby adjust a size of slits between the fixed grating and the movable grating and allowing light to transmit through; extending directions of the slits between the fixed grating and the movable grating are same.

2. A display screen comprising:
a substrate;
a backlight panel, disposed on the substrate;
a fixed grating, disposed on the backlight panel;
a movable grating, wherein the movable grating is disposed above the fixed grating and parallel to the fixed grating, and further can be shifted with respect to the fixed grating in a plane which the movable grating is located in to thereby adjust a size of slits between the fixed grating and the movable grating and allowing light emitted from the backlight panel to transmit through, and therefore for switching bright state and dark state of the display screen.

3. The display screen as claimed in claim 2, wherein extending directions of the slits between the fixed grating and the movable grating are same.

4. The display screen as claimed in claim 3, wherein the backlight panel is an OLED light-emitting backplane.

5. The display screen as claimed in claim 4, wherein the OLED light-emitting backplane comprises R pixels, G pixels and B pixels; the R pixels, the G pixels and the B pixels are distributed in a strip manner.

6. The display screen as claimed in claim 5, wherein the R pixels are driven by a R circuit, the G pixels are driven by a G circuit and the B pixels are driven by a B circuit; the R circuit, the G circuit and the B circuit are mutually independent from one another.

7. The display screen as claimed in claim 6, wherein the R circuit, the G circuit and the B circuit all are disposed at one side of the OLED light-emitting backplane.

8. The display screen as claimed in claim 7, wherein the backlight panel is covered with a packaging layer thereon to protect light-emitting devices on the backlight panel.

9. A display device comprising a display screen, wherein the display screen comprises:
a substrate;
a backlight panel, disposed on the substrate;
a fixed grating, disposed on the backlight panel;
a movable grating, wherein the movable grating is disposed above the fixed grating and parallel to the fixed grating, and further is movable with respect to the fixed grating in a plane which the movable grating is located in to thereby adjust a size of slits between the fixed grating and the movable grating and allowing light emitted from the backlight panel to transmit through, and therefore for switching bright state and dark state of the display screen.

10. The display device as claimed in claim 9, wherein extending directions of the slits between the fixed grating and the movable grating are same.

11. The display device as claimed in claim 10, wherein the backlight panel is an OLED light-emitting backplane.

12. The display device as claimed in claim 11, wherein the OLED light-emitting backplane comprises R pixels, G pixels and B pixels; the R pixels, the G pixels and the B pixels are distributed in a strip manner.

13. The display device as claimed in claim 12, wherein the R pixels are driven by a R circuit, the G pixels are driven by a G circuit and the B pixels are driven by a B circuit; the R circuit, the G circuit and the B circuit are mutually independent from one another.

14. The display device as claimed in claim 13, wherein the R circuit, the G circuit and the B circuit all are disposed at one side of the OLED light-emitting backplane.

15. The display device as claimed in claim 14, wherein the backlight panel is covered with a packaging layer thereon to protect light-emitting devices on the backlight panel.
